(19) United States
(12) Patent Application Publication
(10) Pub. No.: US 2025/0281986 A1
(43) Pub. Date: Sep. 11, 2025

(54) BAND SAW MACHINE BASE STRUCTURE

(71) Applicant: TAIWAN RONG FU INDUSTRIAL CO., LTD., TAICHUNG CITY (TW)

(72) Inventor: BIN CHUN LIN, TAICHUNG CITY (TW)

(21) Appl. No.: 18/662,534

(22) Filed: May 13, 2024

(30) Foreign Application Priority Data
Mar. 8, 2024 (TW) 113202349

(51) Int. Cl. B23D 53/00; B23D 55/02

(52) U.S. Cl. CPC B23D 53/001; B23D 55/02

(57) ABSTRACT

A band saw machine base structure includes a base box having a receiving space. A seat is connected to an underside of a band saw machine. The base box is mounted to the seat and the band saw machine, or the base box is connected to an underside of the seat. By arranging the base box mounted to the seat to protect the band saw machine to avoid collisions during transportation and facilitate packaging, or by arranging the base box connected to the underside of the seat as a stand to increase the height of operation of the band saw machine.

### FIELD OF THE INVENTION

The present invention relates to a band saw machine, and more particularly, to a band saw machine base structure for convenience of packaging and transportation.

### BACKGROUND OF THE INVENTION

Conventional support legs are typically used for support or fixation, providing a stable support effect for a band saw machine and facilitating angle adjustments for operators during processing. Usually, positioning the conventional support legs require them to be placed in the appropriate position and assembled to the bottom of the band saw machine.

However, positioning the conventional support legs usually requires the use of a crane or multiple people lifting together, unless they are disassembled and reinstalled after positioning. Additionally, the conventional support legs typically only provide stable support and fixation, and the debris generated during processing tends to scatter on the floor, requiring additional cleanup after operations.

Furthermore, as shown in FIG. 8, a conventional band saw machine is typically packaged using polystyrene and a cardboard box 91, then lifted and placed inside a container by a forklift. However, the packaged conventional band saw machine still occupies a lot of space, resulting in higher transportation costs. Therefore, there is a need to improve the structure of conventional band saw machines due to the aforementioned shortcomings.

The present invention intends to provide a band saw machine base structure to eliminate the shortcomings mentioned above.

### SUMMARY OF THE INVENTION

The present invention relates to a band saw machine base structure and comprises a base box having a receiving space. A seat is connected to an underside of a band saw machine. The base box is mounted to the seat and the band saw machine, or the base box is connected to an underside of the seat. The base box is mounted to the seat to protect the band saw machine to avoid collisions during transportation and facilitate packaging. The base box is connected to the underside of the seat as a stand to increase the height of operation of the band saw machine.

Preferably, two lifting portions are formed to a top of two sides of the base box. Multiple first connecting holes are formed in the top of the base box.

Preferably, the seat includes multiple second connecting holes located corresponding to the first connecting holes of the base box for mutual screw fixing.

Preferably, a wheel set is connected to one end of an underside of the base box. Multiple fasteners are connected to a lower edge of the base box.

Preferably, a caster set is connected to one end of the underside of the seat.

Preferably, a gripping portion is formed to one end of the seat. A handling portion is formed to each of two sides of the underside of the seat.

Preferably, the seat includes a chip outlet and a recessed area. The chip outlet is connected to the recessed area.

Preferably, the seat includes a collection box which is disposed in the recessed area of the seat. The collection box includes a handle at a center thereof.

The present invention have the following advantages:
1. By placing the base box on top of the seat, the receiving space accommodates the band saw machine to form a square, stackable packaging box body, making it convenient for factory transportation and saving stacking space. This reduces transportation costs, minimizes unnecessary volume and material waste, and aligns with environmental protection principles by choosing recyclable materials. Additionally, when the base box is placed below the seat, it forms a stand for the band saw machine, thereby increasing the operating height of the band saw machine and enhancing the multifunctionality of the band saw machine base structure.
2. By equipping the bottom of the seat or the bottom of the base box with a wheel set, users can lift one end using the gripping portion of the seat or the lifting portion of the base box, allowing the wheel set to touch the ground for rolling. This facilitates simple movement of the band saw machine by users.
3. By providing a recessed area in the seat for accommodating the collection box, debris generated during the band saw machine processing process can roll into the collection box through the chip outlet on the seat. After use, users only need to lift the handle of the collection box to recycle the debris to a designated location.
4. By raising the operating height of the band saw machine with the base box, it conforms to the user's operating height, increasing user convenience and thus improving operational efficiency.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show that the band saw machine is accommodated in the base box of the present invention;

FIG. 2 illustrates the band saw machine located in the base box;

FIG. 3 is an exploded view of the band saw machine base structure of the present invention;

FIG. 4 illustrates that the base box is positioned at the bottom of the seat;

FIG. 5 shows that the collection box is separated from the recessed area of the seat;

FIG. 6 illustrates that the wheel set of the base box touching the ground;

FIG. 7 illustrates the movement of seat by the wheel set touching the ground, and

FIG. 8 shows the packaging of the conventional band saw machine for transportation.

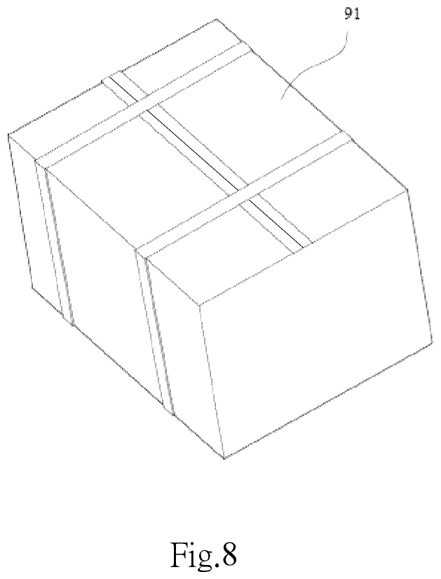

### DETAILED DESCRIPTION OF THE PREFERRED EMBODIMENT

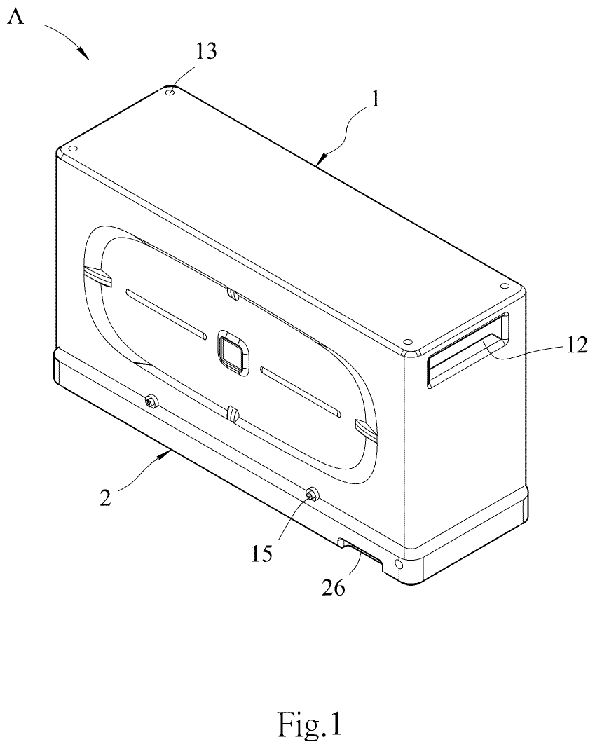

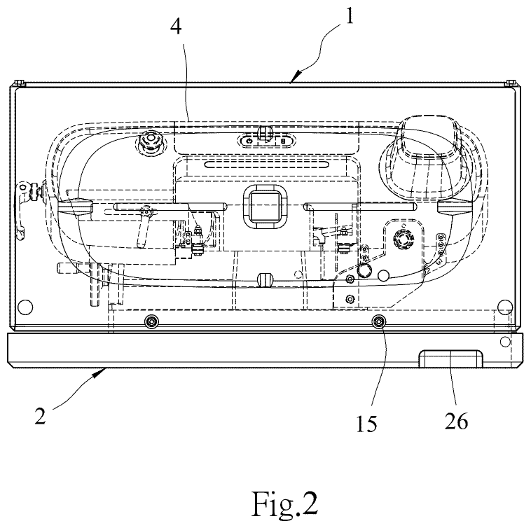

The present invention relates to a band saw machine base structure “A” for a band saw machine 4, designed to facilitate the mobility and lightweight packaging for transportation of a band saw machine 4. Please refer to FIGS. 1 to 3, the band saw machine base structure “A” of the present invention comprises a base box 1 having a receiving space 11. Two lifting portions 12 are formed to a top of two sides of the base box 1. Multiple first connecting holes 13 are formed in the top of the base box 1. A wheel set 14 is connected to one end of an underside of the base box 1, and multiple fasteners 15 are connected to a lower edge of the base box 1.

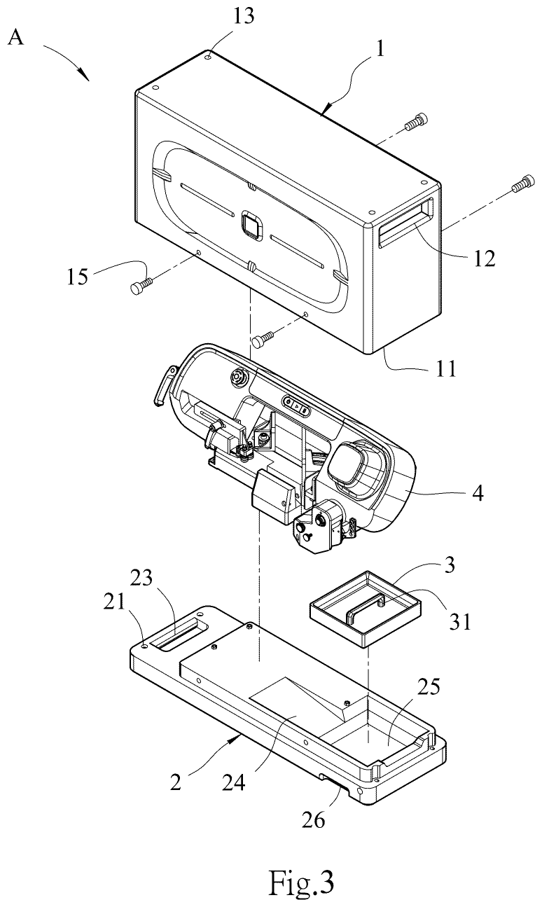

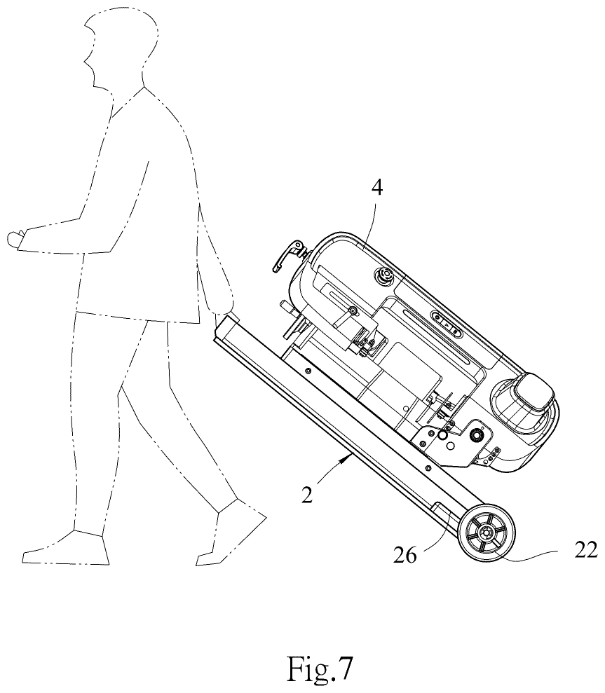

A seat 2 is connected to an underside of a band saw machine 4. The base box 1 is mounted to the seat 2 and the band saw machine 4, or the base box 1 connected to an underside of the seat 2. Specifically, the seat 2 includes multiple second connecting holes 21 located corresponding to the first connecting holes 13 of the base box 1 for mutual screw fixing. The seat 2 includes a chip outlet 24 and a recessed area 25, and the chip outlet 24 is connected to the recessed area 25. As shown in FIGS. 3 and 7, a caster set 22 is connected to one end of the underside of the seat 2. A gripping portion 23 is formed to one end of the seat 2. A handling portion 26 is formed to each of two sides of the underside of the seat 2. As shown in FIG. 3, the seat 2 includes a collection box 3. The collection box 3 is disposed in the recessed area 25 of the seat 2. The collection box 3 includes a handle 31 at a center thereof.

Please refer to FIGS. 1 to 3, the present invention provides three configurations of the band saw machine structure “A” for a band saw machine 4, where the band saw machine 4 is securely placed on the top of the seat 2, and the receiving space 11 of the base box 1 accommodates the band saw machine 4. The seat 2 is fastened to the base box 1 using multiple fasteners 15 to form a closed state, making factory shipping packaging and transportation convenient, reducing volume, and facilitating stacking in containers to save shipping costs.

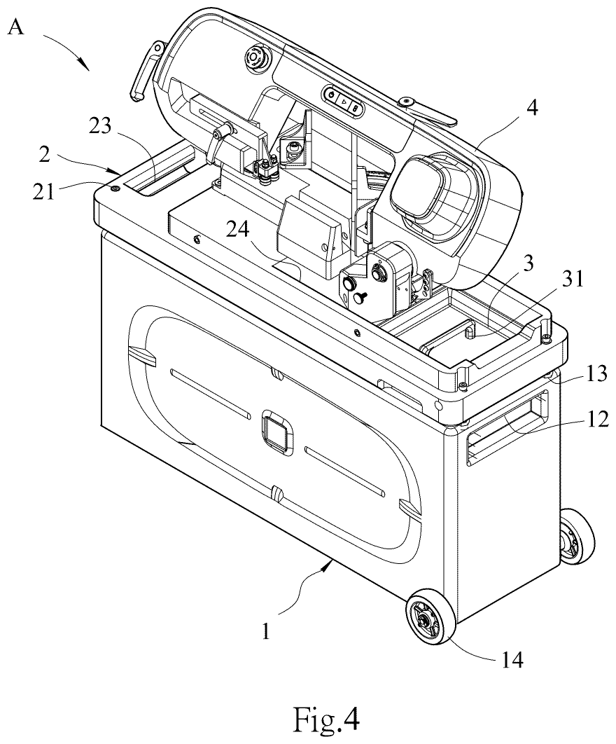

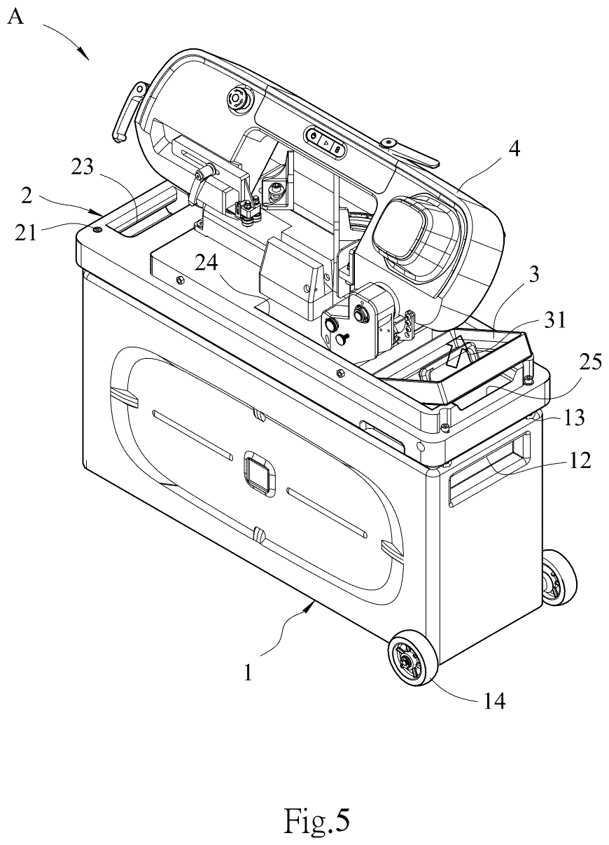

Furthermore, please refer to FIGS. 3 and 4, in the operational state of the band saw machine structure “A”, the seat 2 is fixed below the base box 1 by screwing together through the first connecting holes 13 and the second connecting holes 21. This raises the operating height of the band saw machine 4, facilitating processing operations for users. Please refer to FIG. 5, debris generated during the operation of the band saw machine 4 is collected through the chip outlet 24 into the collection box 3. After use, users only need to grasp the handle 31 of the collection box 3, lift it out of the recessed area 25, and pour the debris into the designated recycling area, providing the band saw machine structure “A” with the function of centralized debris collection, dust, and quick machine cleanup.

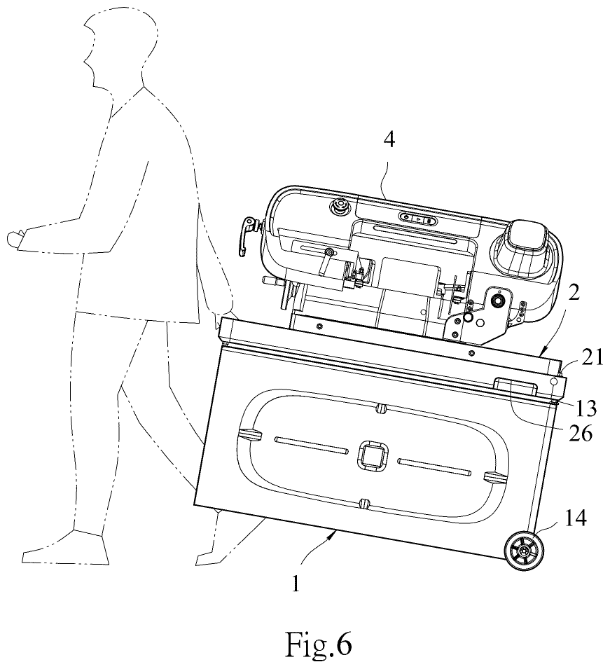

Please refer to FIGS. 3 and 6. if the band saw machine structure “A” and the band saw machine 4 need to be moved to different positions, one can grab the lifting portions 12 of the base box 1 to tilt it, allowing the wheel set 14 of the base box 1 to touch the ground and roll. This enables users to pull the band saw machine structure “A” and the band saw machine 4 to the desired location. Please refer to FIGS. 3 and 7, the seat 2 can also be equipped with the caster set 22. Users can grasp the gripping portion 23 of the seat 2 to tilt it, allowing the caster set 22 to touch the ground and move accordingly.

While we have shown and described the embodiment in accordance with the present invention, it should be clear to those skilled in the art that further embodiments may be made without departing from the scope of the present invention.

What is claimed is:

1. A band saw machine base structure comprising:
a base box having a receiving space, and
a seat connected to an underside of a band saw machine, the base box mounted to the seat and the band saw machine, or the base box connected to an underside of the seat, wherein the base box is mounted to the seat to protect the band saw machine to avoid collisions during transportation and facilitate packaging, or the base box is connected to the underside of the seat as a stand to increase the height of operation of the band saw machine.

2. The band saw machine base structure as claimed in claim 1, wherein two lifting portions are formed to a top of two sides of the base box, multiple first connecting holes are formed in the top of the base box.

3. The band saw machine base structure as claimed in claim 2, wherein the seat includes multiple second connecting holes located corresponding to the first connecting holes of the base box for mutual screw fixing.

4. The multifunctional band saw machine base structure as claimed in claim 1, wherein a wheel set is connected to one end of an underside of the base box, multiple fasteners are connected to a lower edge of the base box.

5. The multifunctional band saw machine base structure as claimed in claim 1, wherein a caster set is connected to one end of the underside of the seat.

6. The multifunctional band saw machine base structure as claimed in claim 5, wherein a gripping portion is formed to one end of the seat, a handling portion is formed to each of two sides of the underside of the seat.

7. The multifunctional band saw machine base structure as claimed in claim 1, wherein the seat includes a chip outlet and a recessed area, and the chip outlet is connected to the recessed area.

8. The multifunctional band saw machine base structure as claimed in claim 7, wherein the seat includes a collection box, the collection box is disposed in the recessed area of the seat, the collection box includes a handle at a center thereof.
